(19) United States
(12) Patent Application Publication
(10) Pub. No.: US 2016/0365987 A1
(43) Pub. Date: Dec. 15, 2016

(54) PERSONAL COMPUTER NETWORK

(71) Applicant: LEI LI, HUMMELSTOWN, PA (US)

(72) Inventor: LEI LI, HUMMELSTOWN, PA (US)

(21) Appl. No.: 14/392,390

(22) PCT Filed: Oct. 27, 2014
(86) PCT No.: PCT/US2014/062405

§ 371 Date: Apr. 8, 2016

Related U.S. Application Data
(60) Provisional application No. 61/962,311, filed on Oct. 25, 2013.
(60) Provisional application No. 61/923,829, filed on Jan. 6, 2014.

(51) Int. Cl. H04L 12/28; H04L 29/06; H04L 12/58; H04L 12/46; H04L 29/12; H04L 29/08

(52) U.S. Cl. CPC H04L 12/2856; H04L 61/1511; H04L 67/10; H04L 51/04; H04L 61/157; H04L 61/1564; H04L 12/4633; H04L 63/083

(57) ABSTRACT

Personal Computer Network (PCN) is a closed network to logically network the global computer users' small network at home through their interfaces and routers. The network architecture contains Local Operating Systems, Regional Operating Systems and Global Operating Systems distributed globally and identified by country codes and area codes. The business informational servers can also be logically connected to the network. The network has module-designed Operating Systems to provide the centralized services to all kinds of computer users. With the module-designed operating systems, the services, functions and features including unifying different kinds of users, providing universal platform, fixed routing, inner connections, universal platform, file system, recording, sorting, multiple Inboxes and intersection searching systems can be developed for the efficiency, sufficiency, flexibilities and convenience. The incoming data and outgoing data in PCN can be separated. Seven layers of TCP are defined, and the transmission with fixed routing is controlled logically.

The international application (PCT/US2014/062405) enters national phase, and apply before the USPTO for the protection.

### SUMMARY

The purpose of PCN network is not only to have a closed network (shown as FIG. 1) to perform the sufficient services, functions and features efficiently for the global computer users, but also to networkize the systems in our lives and solve the problems in our lives as many as possible.

The architecture of the network of PCN consists of Local Operating Systems, Regional Operating Systems and Global Operating Systems distributed globally in the buildings and identified by the country codes and area codes. It logically connects the global computer users (shown as FIG. 3) to the network through their interfaces and routers, and provides them with centralized services of the network. It also logically connects the informational business servers and applications all over the world to the network to provide sufficient services to the global computer users. Any two computer users connected to the network of PCN, no matter the facts that they are from same area or from different countries, communicate each other through the network of PCN (shown as FIG. 2).

All the informational applications are developed in the application servers, which are logically connected to the network of PCN. They can be well organized by the type of the service, content, and location, so that the intersectional searching systems can be more efficient and flexible.

The network of PCN contains module-designed servers and applications, including Networking Server,

Application Control Server, Email Servers, Record

Servers, and Sorting Servers and so on, to expand and extent the services and functions. They cooperate and collaborate each other to centralize the services, functions and features in the network of PCN with physical and logical control (shown as FIG. 4).

The computer users communicate with the network of PCN through their interfaces and routers. The functions of the interface not only control and process the data for the user's computers and communicate with the network, but also have Network Directory designed to define the catalogue and geography of the business applications and servers connected to the network for the intersectional local or global searching (shown as FIG. 5 and FIG. 6).

Seven TCP layers in PCN have been defined to transmit the data, including: Interface Layer, Date Link Layer, Transmission Layer, Network Layer, Transport Layer, Application Layer and Control and Management Layer. The transmission in the network of PCN can be logically controlled (shown as FIG. 7).

One of the features of the network of PCN includes the fixed routing. The sending application or application server determines the fixed routing logically controlled by TCP Availability Server, Time/Route Table and the Rules of Fixed Routing. If it is global transmission, the sending application or application server only determines the fixed routing in its own country. When the data reaches the foreign country, the application or application server in the foreign global operating system will determine the fixed routing in its country for the purpose of efficiency.

In the network of PCN, the data structure between the interface of computer user and the network layer (shown as FIG. 8) is different from the data structure flowing inside the operating systems (shown as FIG. 9), resulting from the purpose of the transmission and functions and features of the network of PCN. At mean time, the incoming data and outgoing data can be separated with the direction indications in the data structure, and the different ports for different type of services can be defined for the efficiency as well (shown as FIG. 10).

Inventions
1) Personal Computer Network (PCN) is a closed network logically connecting global computer users and informational and functional business applications and systems to the network (shown as FIG. 1).
2) Personal Computer Network consists of user's home network, Local Operating System, Regional Operating System and Global Operating System distributed globally and identified with country codes and area codes, as well as the business informational servers and application logically connected to the network (shown as FIG. 2).
3) Local Operating System, Regional Operating System and Global Operating System contain module-designed functional servers, such as Network Server, Email Server, Record Server, and Sort Server and so on to provide the centralized services to the global computer users. All the functional servers and applications are module-designed for the purpose to extend and expand the functions and services of the network (shown as FIG. 4).
4) The global computer users are logically connected to PCN network through their interface and routers.
5) The user's computers have an open configuring design which allows the network of PCN to update its configurations in order to receive the expanded and extended services and functions of PCN.
6) The user's computers are considered as a small network, consisting of computers, printers and so on, and connected to the interface at home, which functions as central server of small network and communicates with the network of PCN. The interface also controls and processes the data for the computers at home.
7) The interface is also designed to have Network Directory, which defines the catalogue and geography of the information business applications and application systems for the local and global searching systems in the intersection manner.
8) The router connecting the computer user is used not only to transmit the data between the interface and the network, but also to logically connect the computers to the most favorable local operating system.
9) The elements' addresses in the network of PCN, including elements of the informational applications and application systems can be identified by country code+area code+identification numbers. For the business informational applications, the identification numbers define the catalogues of the applications. It increases the efficiency of searching in the network of PCN greatly.
10) The network layer of PCN not only authenticates the computer users, but also communicates with the computer users and functional servers inside the network.
11) Email Server in PCN network can allow Email Transmission Protocol (EMTP) to be a type of service for the emails. The computer users can have multiple inboxes to receive different kinds of emails, resulting from the functions and features of the architecture of PCN.
12) Based on the architecture of PCN, the network can have a lot of features, including Inner Connections, Recording functions to record all the performance of the computer users and applications and application servers, Sorting functions to sort out the informational applications by the contents so that we can keep improper information from children.
13) The major feature of the network of PCN is logically controlled fixed routing, which is Determined by the sending application server.
14) The fixed routing is determined by the sending application or application server with the rules. If it is global transmission, the sending application or application server determines the fixed routing in its own country. After the message reaches the foreign country, the foreign global operating system in the foreign country will determine the fixed routing in its country.
15) The searching systems in the network of PCN include Local Searching and Global Searching with the definition of catalogue and geography in the interface of computer user.
16) The network of PCN is using intersectional searching technologies which allow the searching to switch between the geography and catalogue flexibly.
17) The data structure between the users and network is different from the data structure flowing inside the network of PCN.
18) The data directions are separated for the incoming data and outgoing data, and different ports are assigned for the different type of services

### DRAWINGS

FIG. 1: Closed network of PCN

FIG. 2: Network connections with computer users and business informational application

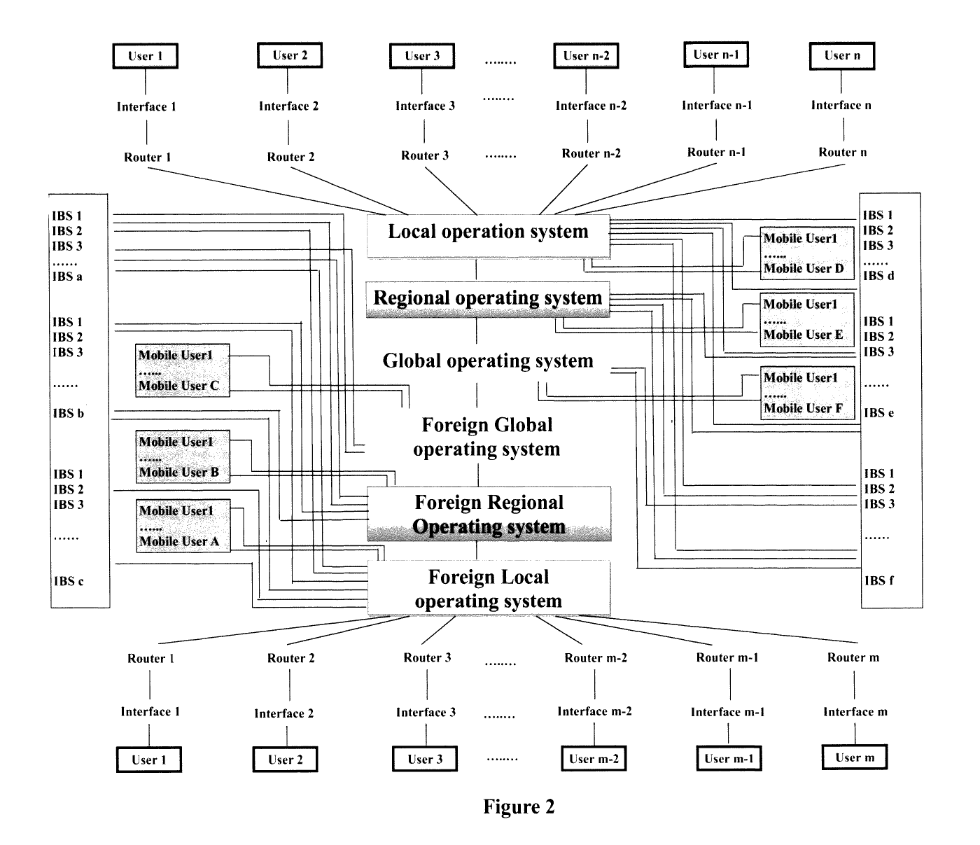

FIG. 3: Network logic connections of global users in groups

FIG. 4: Module-designed Local Operating System, Regional Operating System and Global Operating System

FIG. 5: Intersecting searching system with definition of catalogues and geography

FIG. 6: Intersecting Searching system with multiple Application Name Servers and Browsers.

FIG. 7: Seven TCP layers defined in the network of PCN

FIG. 8: Data structure between the computer user and the network layer

FIG. 9: Data Structure for the data flowing inside the network

FIG. 10: Definition of the directions of data transmission and different ports can be assigned for different type services. The Interface layer and Network layer are shown.

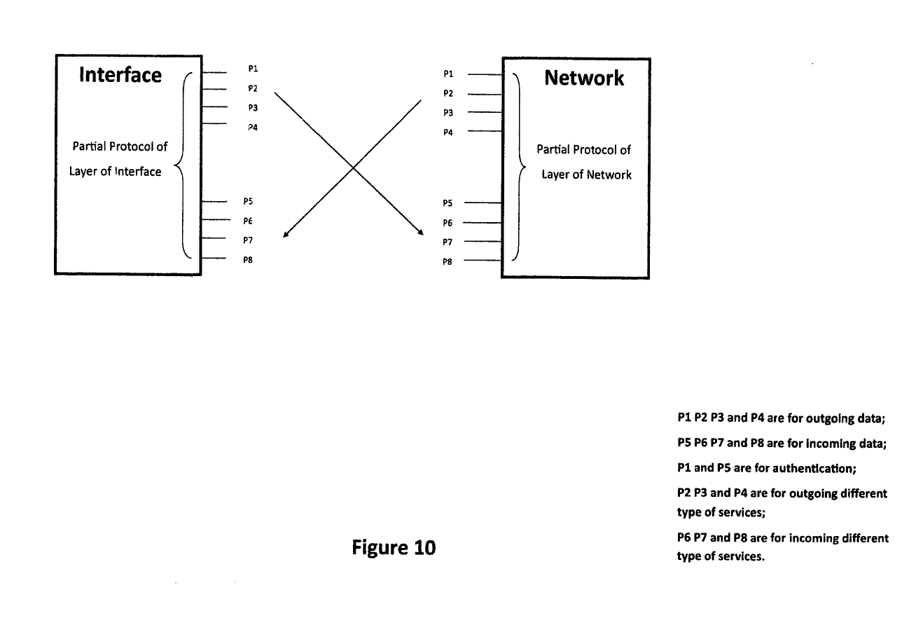

### DESCRIPTION

Purpose of the Network

The purpose of PCN network is not only to have a closed network to perform the sufficient centralized services, functions and features efficiently for the computer users, but also to networkize the system in our lives and solve the problems in our lives as many as possible.

For example, we use “Home Security System” today. After PCN network is developed, the Home Security System can be computerized and networkized with PCN as an application, so that people can use Home Security System from PCN network for high security.

We also can use PCN network to solve the problems that we have today. The network of PCN can sort out the applications by the contents, so that we can keep improper applications from our children by ordering the proper applications from PCN for the family.

PCN network can also improve our lives by using PCN for semi-procedure. For example, we can use PCN network to place the orders of services. The service providers can use either their own separated network to process the orders, or the system connected to the network of PCN to process the orders, and use PCN network to improve the quality of services.

Architecture of the Closed Network of PCN

In the network of PCN, the computer user connects their computers to the interface at home to form a small home network. The interface functions as central server of the small home network, not only to control and process the data for the computers, but also to communicate with the Local Operating System. The interface also has Network Directory to define the catalogue and geography of the application for the intersectional searching.

The computers in small network at home will be designed differently for the network of PCN, as the network of PCN will be designed to centralize the services, functions and feature. The computers will have an open configuring system, so that the network of PCN updates all the services, functions and features inside the network and updates the users' computers through the service providers flexibly. The open configuring systems of users' computers at least need be designed to meet the demand of expanding and extending of the network, for the purpose to communicate with the service providers and updated by the network.

The architecture of the closed network consists of home small network, Local Operating Systems, Regional Operating Systems and Global Operating Systems distributed globally in the central buildings and identified by the country codes and area codes.

All the elements in the network have their own identification numbers, and the element address in the network can be established by the country code+area code+its identification number. The same elements in different operating systems will have same identification numbers. For example, the element's address in Email Server in the local operating system located in Hershey, U.S. will be differed from the same element in Email Server in the operating system in Shanghai, China by the country code and area code.

To define the identification number of the informational application or application system logically connected to the network of PCN can be critical for the searching systems, because the identification number can be used to define the catalogue for searching. Identifying the applications, which are in same catalogue, with exactly or partially same identification numbers can increase the efficiency of searching in the network of PCN. The definition of identification numbers can help increase the efficiency of searching in the network of PCN.

So are the country code and area code, which define the address with the identification number. The searching systems of network of PCN can be very efficient with the definition of addresses, which is country code+area code+identification codes, and results in the facts that the identification number can be used for the local searching.

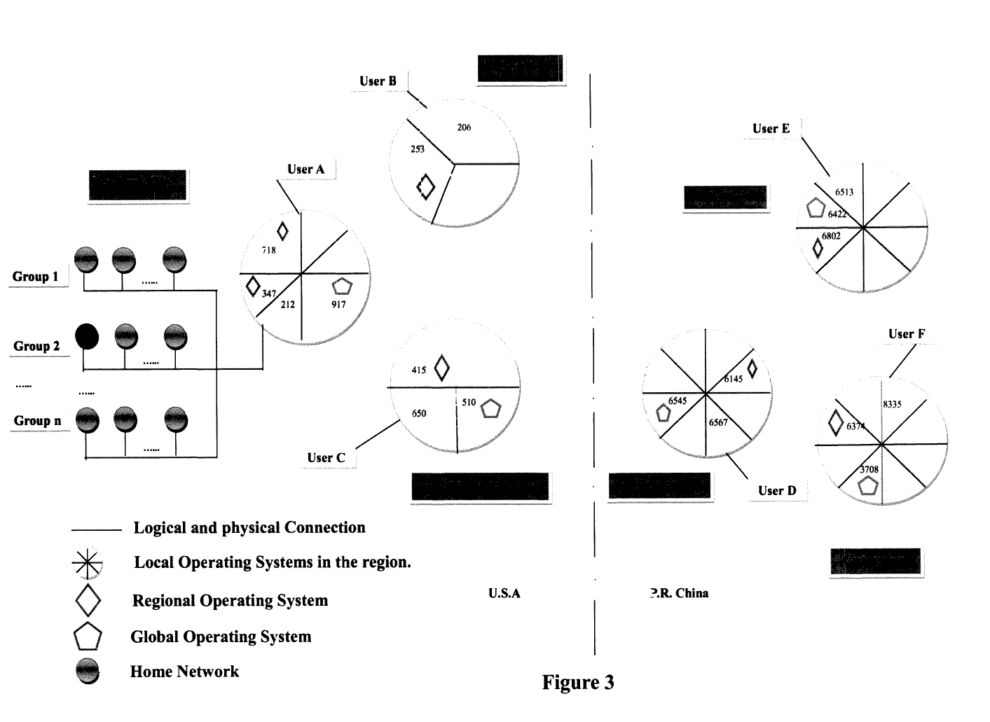

The users to be logically connected to the network of PCN are divided into the groups. Their routers functionally modulate, multiplex, and centralize the data and group with other users' data, so that the network of PCN will be able to logically connect the computer users into the network (shown as FIG. 3).

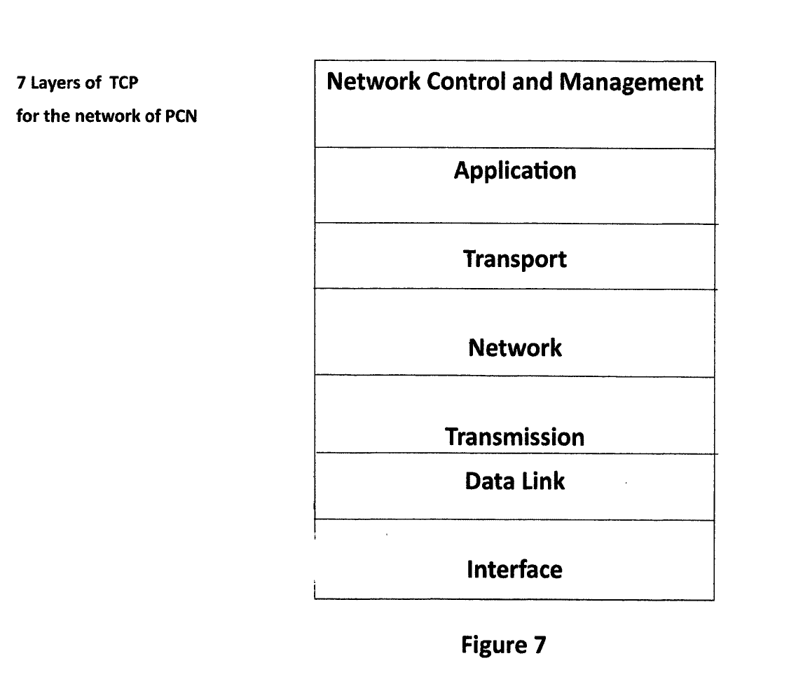

Seven layers of Transmission Control Protocol (TCP) have been defined in the network of PCN. They are: Interface Layer, Data Layer, Transmission Layer, Network Layer, Transport Layer, Application Layer and Control and Management Layer (shown as FIG. 7).

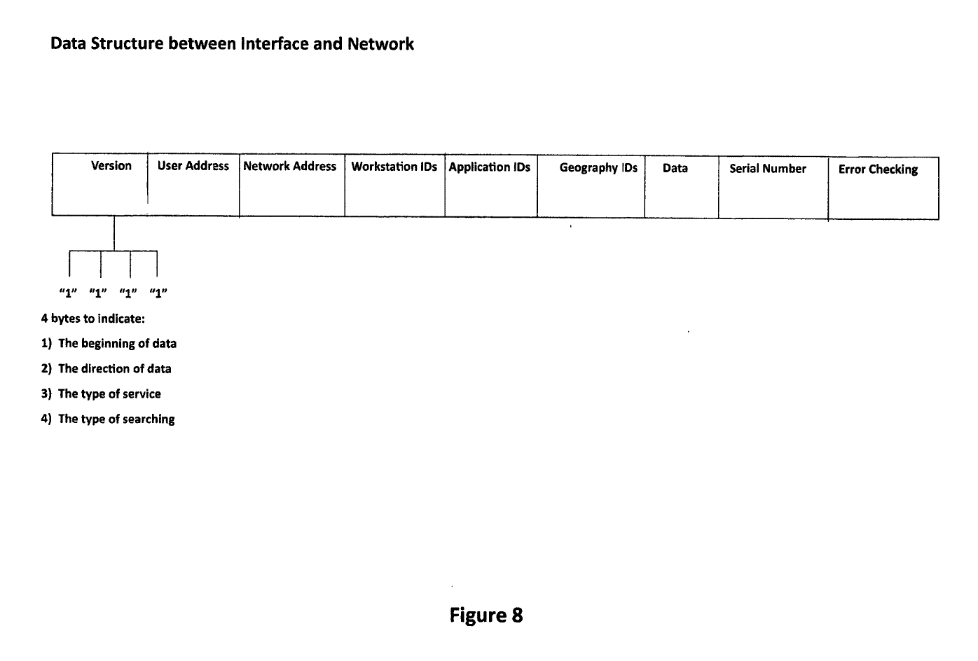

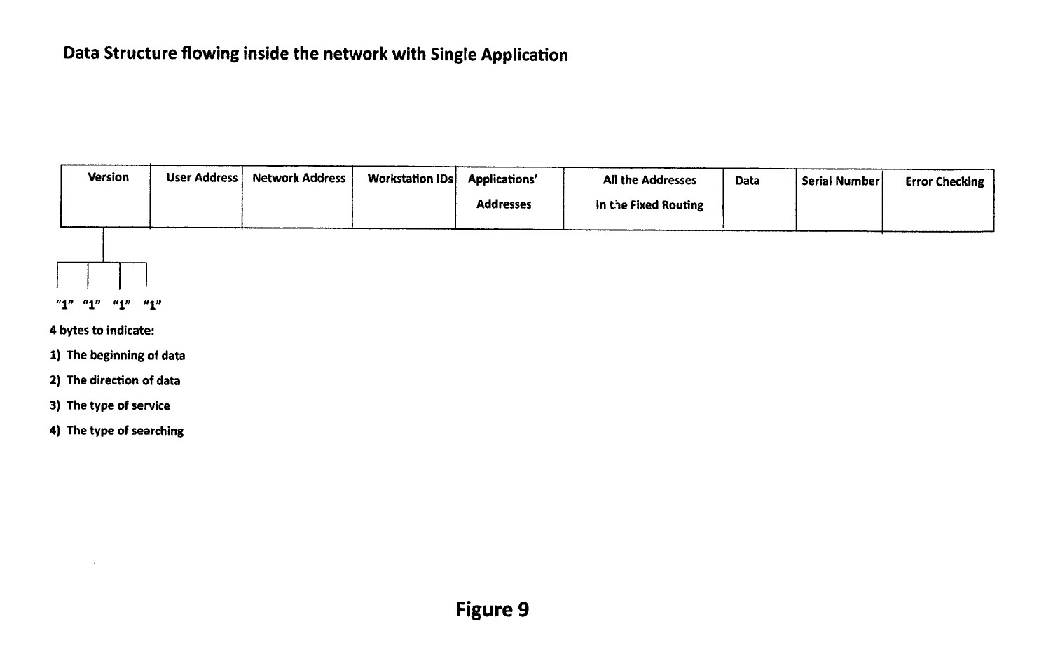

The data structure between the computer user and the network layer (shown as FIG. 8) is different from the data structure flowing inside the network (shown as FIG. 9). With the architecture of the network of PCN, the network of PCN will have a fixed routing to transmit the data, so the data structure flowing inside the network of PCN will have all the addresses in the structure, instead of only sending address and receiving address. At meantime, the data structure between the user and the layer of network will have only sending address and receiving address with all the information of user's computers.

The network layer is used not only to communicate with the computer users, but also to communicate with the functional servers and applications inside the network, as well as informational business systems and applications connected to the network of PCN.

More importantly, to process the data from the users, the network server can separate the data from the users by the type of service, and integrate them by with unitary applications and sort them by the location, before sending them to the destination. Therefore, the layer of Network need have a large capabilities and good processing ability.

With the architecture and definition of the seven layers of TCP for the network of PCN, the data flow and congestion will be in good logical control in the network.

Since the network of PCN is a system network, the Interface Control, Data Link Control, Path Control and Transmission Control are needed to logically connect the users to the local operating system, and transfer the data from one host to another inside the operating systems. We also need Data-Flow Control and Application Service Control to manage and control the performance inside the network.

Each server in the operating system has its own processing control unit(s) in order not only to control the processing of the performance in the server, but also to cooperate and collaborate with other servers, including the control and management servers, Application Control Server, TCP Availability Server and so on. Some of them have more than one processing control units in order to perform more functions for the network of PCN.

With the architecture of PCN, universal platform can be provided by the network, so that the operating systems, such as Windows, UNIX, MAC and so on which are used to develop the business informational applications and systems can be compatibly work in the network of PCN. These different kinds of operating systems used to develop the applications will be unified and work well! in same network with the universal platform.

With the architecture of PCN, more features can be developed, such as record function to record the performance of the computer users and operation of the applications, as well as file system to store and retrieve the files for the users and so on.

In PCN network, the fixed assignment scheme, centralized assignment scheme and distribute assignment scheme can be applied to fully function for the global network.

In PCN network, more than HTTP and FTP services will be used for the searching functioning. For example, the network of PCN can networkize the systems, such as “Home Security System” that we use today directly from the security company. To connect the systems like “Home Security System” to the network of PCN, we will need a new type of service which is able to connect and retrieve the functions from the whole system of “Home Security System” to the network of PCN.

The Internet uses Domain Name for the searching, and Domain Name is classified in the Internet, and its IP is classful. In PCN, we use Application Name for searching. The classification (catalogue) and geography of the application are defined in the interface and the identification number of the application is coded by its classification (catalogue) and the address is coded by its country code and area code and identification number. The searching systems in PCN consist of Local Searching and Global Searching. The detailed searching system will be discussed in the section of Searching Systems.

Interface

Interface is a central server of the small network at home, which connects the computers, and controls and processes the data for the computers in the small network. At meantime, it communicates with the network for the computers in the small network. The interface layer is defined as the first layer of TCP in the network of PCN.

The interface also has a Network Directory, which is designed to define the catalogue and geography of the applications for the purpose to establish the local searching system and global searching system in the network of PCN. At mean time, the catalogues of applications will be coded in the level as per the names of catalogues. For example, the code for Physician is 0001 0000, while the code for the dermatologist is 0001 0001, and the code for the ophthalmologist 0001 0002.

Each different catalogue will have different identification number. The different catalogue applications will have different identification numbers, resulting in the different addresses in the network of PCN for the searching systems.

Network Directory in the interface defines the geography of the applications with the name of the location, as well as the country code and area code. This flexible definition of geography with names of the locations, even their country code and area code are same, gives the searching systems with the Flexibility. Defining geography in the interface flexibly, with defined multiple locals, regions or countries, can provide the scale of searching systems in the network of PCN.

Router

The computer user over the world is connected to the most favorite local operating system logically through their router. The major functions of the router include: routing the computer user to connect to the most favorable Local Server, modulating, multiplexing and centralizing the data to connect to Local Operating System logically with other users who are divided in the same group or different groups.

It means by “the most favorable Local Server” that, sometimes, the computer users need be logically connected to the remote Local Server other than the local server which they register with, in order to well control the traffic in the network of PCN. The router can function to routing the computer users to the most favorable local server with the logic traffic control of the network of PCN.

To logically connect the users in the area into the local operating system of the network of PCN, the users in the area will be divided into the groups. The users in the group will use their routers to connect to the network and communicate with the network through interfaces. Then, each group will be centralized with other groups and connected into the network.

The router modulates the data from the interface which will be logically multiplexed with other users in the group and centralized with other groups into the network.

Data Structure of the Network of PCN

First, we discuss the data structure from the interface to Network, which at least contains the following information: Version, The indication of service type, The beginning of data packets, The direction of data and searching type, User's address, Network address, User's computers' IDs, Application IDs, Application geography (if any), Serial number and Error checking.

As discussed in searching system of the network of PCN, we can define the local searching and global searching at the interface. If local searching is defined, the data link control will define the destination addresses of the network, along with the application IDs and geography of applications. The layer of network separates data packets from the users' interfaces, integrates them into unitary applications by the type of service, and sorts them by the location before sending them the destination servers.

The user's computers at home can be identified simply. We suggest that the ID of the user's computers at home should be with their requested application ID in the data structure for the easy processing at the interface and in the network.

It is an advantage of the network of PCN to use more than one port controlled by the protocols logically to transfer the data at the layer of interface, the layer of network and all protocols of the layers inside the network. Therefore, we can use different ports not only for the different type of services, but also for the better management and control purpose, for example, to separately control the incoming data and outgoing data.

For example, we can use independent port for EMTP (Email Transmission Protocol) in order to make email service in the network function more efficiently and sufficiently. It is same reason to use separate port for different type of services.

The data structure from the interface to the network is shown as FIG. 8, and the data structure flowing inside the network is shown as FIG. 9.

To coordinate and collaborate with the interface, the layers of network will have multiple ports as well, such as the port for EMTP, the ports for different service types from the HTTP to the new one to be able to function for more application systems connected to the network of PCN, in order to increase the efficiency of the network.

We use example of the service EMTP to indicate the process at the layer of network. As we have discussed, the network of PCN may have a separated EMTP for the email service from other type of services, and the layer of application will sort them out by the country codes and area codes before sending them to the destination server in the network. Email service in the network of PCN can become an independent service and controlled well with the regulations, so that the problems of emails today can be resolved.

The unitary applications can be defined by the type of service, as well as special services such as Microsoft Office, Amazon, Good Search, Home Security System, and secret applications and so on.

Applications and Application Servers

The applications refer to the business informational applications, which are developed in the application servers either in the network of PCN or logically connected to the network of PCN. The application address is established with the country code, area code and identification number.

The applications in the network of PCN include: Public Applications, Private Applications and Secret Applications. The public applications include Email Server and Telephone Server and so on. In PCN, we don't have to have numerous applications to provide email service. In PCN, email service can be considered same as our post mail service from United States Post Office under our government regulations.

The public applications can be defaulted and switched to private applications by engaging HTML links in the pages of public applications. The transfer between the public applications to private applications can occur with the tool bar or manual of Standard Display Page which is configured with all services, functions and features.

Secret Applications can be defined and applied by configuring properly for the people related. All the application servers in the network of PCN are logically connected each other, unless some of applications are Secret Applications, and some of applications are not associated with other applications.

Most Applications in PCN network are private application, including Customized Applications. All the private application can be searched with both local searching and global searching in the network. After the computer user orders the applications to the network service provider, the network will configure the interface of the user's computers and the user's computers to receive the services of applications.

There are different kinds of customized applications. “Home Security System” used today can be considered as Customized Application after it is computerized and networkized to the network of PCN. At mean time, the network is configured for the application of “Home Security System” and configuring the user's interface and the computer to receive the service of “Home Security System”.

The second kind of customized applications is that the ordered applications can be shown on the screen as an icon without searching. For example, if a football fan wants to follow his team and have his team's information always show on his computer without searching, all he needs to do is to order the team's application to Network Service Provider. Then, his computer will be configured to have his team on the screen with an icon as same as Microsoft Word Processor icon on his screen today. The team's application will be separated from other applications in the server.

There is another kind of customized applications, such as Microsoft Office, Google, Amazon or Facebook. PCN network can have this kind of customized applications as a package to provide their services to the computer users. After the network of PCN configures the user's computers, it is just a click away for the computer users to apply these services through the network.

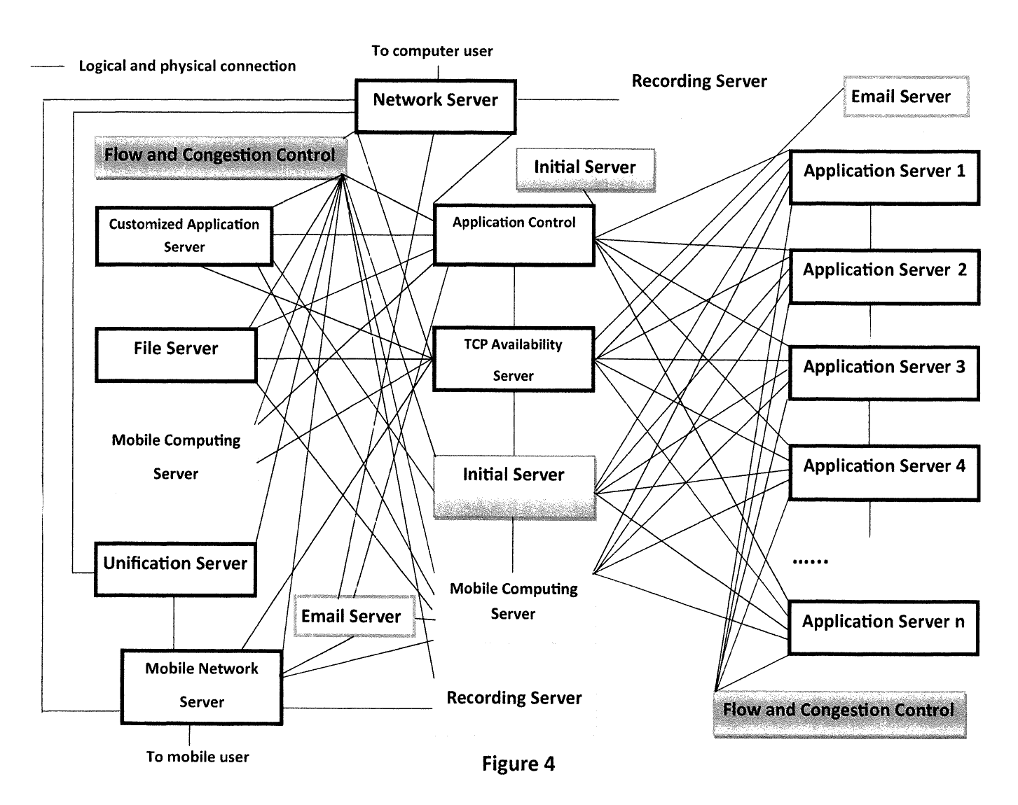

The computer users should not download any kind of program from the sources outside the network. The updated information of the applications should be provided by the network. The user's computer stations will have open configuring systems and be configured by the network in order to receive the services that the network provides. All the configurations for customized application are established by the specific functional server in the operating system, called Customized Application Configuration Server (shown as FIG. 4).

For searching, specially local searching, the identification number of application is critical. It indicates the catalogue of the application, and can be defined with Network Directory in the interface. Since the searching systems of the network of PCN consist of local searching and global searching, each element in the address of application, including the country code, area code, and partial or whole identification number, can be searched partially or completely to increase the efficiency of the searching in the network.

All the applications are developed in the application server(s). Each application server has its own Application Name Server and Browser, including Initial Server for global searching which also has its own Application Name Server and Browser. Multiple Application Name Servers and Browsers will be developed in the network of PCN for searching.

The applications can be always presented to the computer users in the standard displaying page in the orders of alphabet, size of business, distance of business and the popularity in the network of PCN. TCP protocols in the network of PCN

With the architecture and connections of PCN, seven layers of TCP protocols are defined to reduce the complexity of the end-to-end communication in the network of PCN with logical control. The defined seven layers of TCP include: Interface, Data Link, Transmission, Network, Transport, Application and, Control and Management (shown as FIG. 7).

In the internet network, TCP/IP protocols bring the computer users into an open and unreliable network. With the open and unreliable network, the user's IP became vulnerable. In the closed network of PCN, User Protocols (UP) can be reliable, and the whole network of PCN can be reliable as well with the logical control of the interface control, data link control, path control, transmission control and data flow control inside the network.

User Protocol (UP) is defined to connect the user to the network. The data structure at User Protocol (UP) contains Version, Source address of User Protocol, Destination Address of Network Protocol, Workstation Identifications, Application Identifications and their Geography, Data (shown as FIG. 8). Inside the version, there are indications of the beginning of data, direction of data, type of service, and local searching or global searching.

Since there will be more service types in the network of PCN than HTTP, FTP and so on, we need indicate the type of service in the data. We can add the codes of the types of service in the Version along with other indications. We also can need to identify the beginning of data, the direction of data and type of searching.

For the layer of interface, its functions include controlling and processing the data to/from the network, transferring the data from/to the home stations, and being configured logically by the network of PCN and configuring the home stations logically and physically as well, in order to cooperate and collaborate with the network of PCN.

For the layer of Data Link, it encapsulates the data into the packets and the layer of transmission sends them to the network. The layer of network authenticates the users connected to the network. To process the data from the users, the layer of network will separate the data from the users by the type of service, and integrate them by unitary applications with same type of service and sort them by the location, before sending them to the servers at the destination.

The data flowing inside the network of PCN is structured fundamentally with clear indication of the beginning and the end of the data packets so that the synchronization can be provided for the efficiency when the asynchronous control is not necessary. The structure also includes the user's address, network address, application addresses, and the all the addresses in the fixed routing, serial number and techniques for checking errors.

The layer of network not only has two separated ports for the incoming data and outgoing data to communicate with the interface, but also has two separated ports for the incoming data and outgoing data to communicate with the functional servers inside the network.

The layer of network is also connected to other functional servers in the network of PCN, such as Record Server, Application Control Server, Customized Application Server, Mobile Network Server, Mobile Computing Server and Mobile Unification Server and so on to cooperate and collaborate with other servers, including the layer of Control and Management.

For these purposes, the layer of network need be in large capability and good processing ability. More protocol ports need be applied for the layer of network for the efficiency, so that the functions, features and services in the network of PCN can be carried out unitarily and efficiently with a reliable performance of the Network Layer.

For example, User 1, User 2, User 3 . . . User n are sending emails with EMTP. After receiving the data, the layer of network sends them to Email Server to sort them by the locations from sending them to Email Servers at the destinations.

The layer of transport is to transfer the data from one host to another. As known, these seven layers of TCP will be used completely or partially every time to accomplish the service of application. The transfer of data from one host to another is using fixed routing which is determined by the source server (sending server) and logically controlled to reduce the complexity of end-to-end communications. The detail will be discussed in the section of Fixed Routing.

The layer of Application is a functional application layer, such as Application Control Server, Email Server, Customized Application Server, and so on. The layer of application is to cooperate and collaborate with each other to perform the functions and features of the network of PCN.

The layer of Control and Management is to control and manage the performance of the network of PCN with the logic connections to the functional applications and informational applications. It makes the network in good performance with logical control. For example, after the fixed routing is determined by the sending application server, the layer of Control and Management will control and manage each port on the routing with the TCP Availability Server and Routing/Time Table to make sure the fixed routing will be operated without interruption.

More than one kind of TCP can be used in the network of PCN as well to increase the efficiency of the network of PCN, including the protocols of Async, Bisync or SNA.

Module-Designed Operating Systems

The network of PCN has module-designed local operating systems, regional operating systems and global operating systems to expand and extend the capabilities and services. The module-designed servers, such as Network Server, Application Control Server, Application Servers, Initial Server, TCP Availability Server, Customized Application Server, Mobile Network Server, Mobile Computing Server, Mobile Unification Server, Record Server and Sort Server and so on in the local operating systems, regional operating systems and global operating systems cooperate and collaborate each other to centralize the services, functions and features in the network of PCN with physical and logical connections (shown as FIG. 4).

Module-designed operating systems can also provide more functions and features for the network of PCN to increase the sufficiency, efficiency, flexibility and convenience of performance and innovation of the network of PCN.

Although the capability of each local operating system is different as per the population of the users in the local and the equipment that local operating system has, all these servers embody local operating system physically and logically and are designed practically in logical and physical connections to provide the services, functions and features for the local computer users.

All these module-designed servers in local operating systems, regional operating systems and global operating systems cooperate and collaborate each other to function. For example, Network Server is not only to networking the computer users, but also coordinate with Mobile Network Server and Mobile Computing Server for the unification function. At mean time, Application Control Server is not only to coordinate with user's interface and Application Servers to conduct the searching systems, but also to cooperate and collaborate with Network Server for user's service requests, as well as mobile servers for mobile user's requests. Application Control Server can be also used to sort the service types of the applications by the location, and make unitary application data flowing in the network.

The module-designed servers also have their own processing control unit to control the performance of the servers. Some of them may have more than one processing control unit for the performance of servers. All the processing control units cooperate and collaborate each other to control the performance of the network of PCN.

Searching Systems

In the network of PCN, the searching systems consist of Local Searching System and Global Searching System. In the interface, there is a Network Directory designed to define the catalogue and geography of the applications connected to the network. When the catalogue and geography are both defined with the Network Directory in the interface, the searching in the network will be local searching. If only catalogue or geography is defined, the searching in the network will be global searching. Local searching can be switched to global searching, and the global searching can be switched to local searching as well with the tool bar and manuals in the standard displaying page.

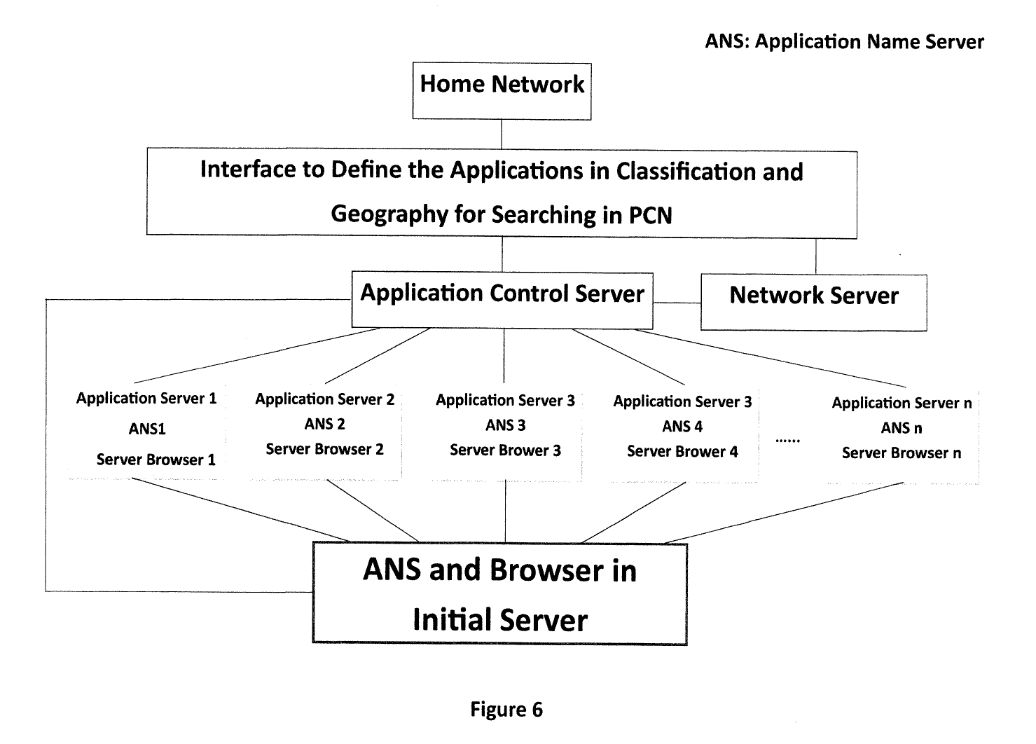

All the informational business applications and systems are developed in the servers and logically connected to the network of PCN. Each application server has its own Application Name Server and Browser (shown as FIG. 6).

The searching systems in the network of PCN use multiple Application Name Servers and Browsers to conduct the local searching and global searching.

The types of services, such as HTTP, FTP, and EMTP can be defined and designed for searching. At meantime, more type of services will be designed and developed for searching and retrieving the applications, such as “Home Security System” and other Customized Applications.

The network of PCN also has a standard displaying page to present the results of the searching. The standard displaying page also has functional tool bar and manuals. With the tool bar and manuals, local searching and global searching can be switched each other.

The identification number is part of the address, which is: country code+area code+identification number. The identification number of the application defines its classification and the levels of the classification inclusively. For example: the identification number of physician is 0001 0000, while the identification number of dermatologist is 0001 0001, and the identification number of ophthalmologist is 0001 0002. It helps establish the identification system of the application for searching.

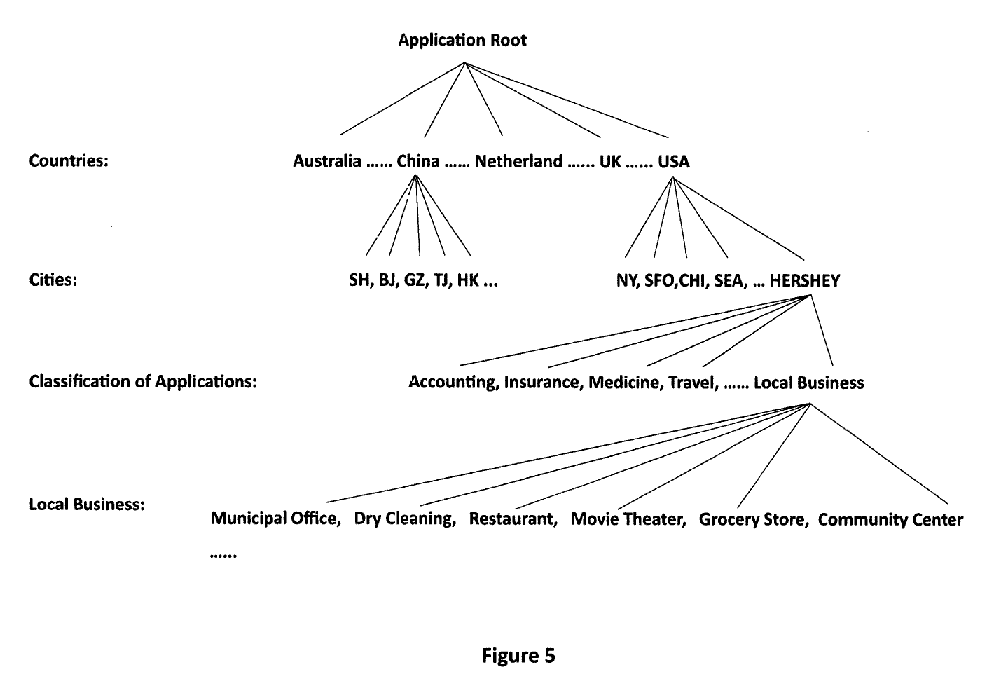

The searching in the network of PCN is using the method of intersection searching, which means that definitions of classification or location can be crossed during the searching with the defined classification or location. The detail is shown as FIG. 5.

With the definition of Local Searching and Global Searching, the structure of addresses of informational applications: country code+area code+identification number, and the searching manner of intersection, the searching in the network of PCN can be efficient, sufficient, flexible and convenient.

With the architecture of the network of PCN, the scale of the searching can be defined in the detailed locations for the efficient searching. The scale of the searching can be defined in the multiple locals, multiple regions or multiple countries specifically. For example, if we need to search a specialist near Hershey area in Pennsylvania of the United States, we can set the scale of searching in the locals of central Pennsylvania, including Hershey, Lancaster, Harrisburg and Lebanon; If we need to search a specialist in different states, we can set the scale of searching in the area of northeast of the United States; If we need to search a specialist in the different countries, we can set the scale of searching in the countries, like the United States, British England, and China and so on.

The global searching can be conducted relatively after the scale of searching is defined. It means by “relatively” that the network of PCN will conduct the searching in any scale defined.

In internet, Domain name is used for the searching, and Domain Name is classified in the internet. Its IP address is classful. In PCN, we use Application Name to searching. Each Application has a name, and each application has an address. The classification (catalogue) and geography of the application are defined in the interface, and its identification number is defined by its classification. Its address is coded by its country code, area code and identification number.

The searching in the network of PCN uses multiple Application Name Servers (its function is same as domain name without the definition of classification and geography for the internet). The searching in the network of PCN also uses multiple Browsers for searching. Each Application Server has its own Application Name Server and Browser for the local searching, while there are Global Application Name Server and Browser for global searching (shown as FIG. 6).

Fixed Routing

In internet, a connection need be established between the source host and destination host for the data to be transferred with the procedure: request, acknowledge and connection.

The connection in the network of PCN can be controlled logically. At mean time, the connection in the network of PCN can use the fixed routing to transfer the data logically with TCP Availability Server and Time/Routing Table. The fixed routing is determined by the sending application or application server.

There are rules of fixed routing in the network of PCN: the computer user communicates with local operating system; two users who are connected to the same local operating system communicate each other through their local operating system; two local operating systems in the region can communicate each other; regional operating system can communicate with any local operating system in the region; two regional operating systems in the country can communicate each other; global operating system can communicate with any regional operating system in the country; and two global operating systems in the world can communicate each other.

In PCN, all the nodes or paths from the source to destination are controlled logically by TCP with the information from TCP Availability Server and Time/Routing Table. TCP Availability Server contains the information of status of all TCP. Time/Routing Table is logically connected to TCP Availability Server to dynamically control the change the time needed from one host to another host. Time/Routing Table contains the information of transmission time between the nodes in the fixed routing.

TCP Availability Server is designed for the network of PCN to dynamically record the status of all the TCP protocols in the country, and provide the application servers with the information of status of the protocols, so that the application servers can determine the fixed routing to transfer the data in the fastest, safest and most efficient in the fixed routing. TCP status include: idle, busy, error.

Each country will have their own TCP Availability Server to record their TCP protocols in the country, because the fixed routing is determined by the source application in the country. As soon as the data reach the foreign country, the foreign application server will determine the fixed routing in its country with its own TCP Availability Server.

More than one kind of TCP can be used as well in the network of PCN to increase the efficiency of the network of PCN, including the TCP protocols such as Async, Bisync, or SNA. They will have their own TCP Availability Server to increase the efficiency of the network.

Traffic and Congestion Control

The level to control the traffic and congestion can be performed at the level of the protocols and between the nodes in the end-to-end communication in the network of PCN logically to reduce the complexity of the data flowing in the network of PCN.

The end-to-end control attempts to insure that the destination host receives the data packets without error. Logical control can reduce the error in the end-to-end communication. It is a major feature of the network of PCN to use logical control to perform the functions, as well as control the traffic and congestion in the network of PCN. But, accident happens. We should use full advantages of the architecture of the network to transfer the data efficiently and reliably. For example, TCP Availability Server in the network can provide us with the information of all the TCP in the country. After the sending server determines the fixed routing, Time/Routing Table connected to TCP Availability Server can be established to make sure the transmission with fixed routing will be carried out without error.

We should also consider how to control the traffic and congestion in the aspects of reality vs policy control and reactive vs preventive control. We use an example to explain them:

As aspect of reality vs policy, we have rules of fixed routing. It says that any two global operating systems can communicate each other, any global operating system can communicate with any regional operating system in the country, and any two regional operating systems in the country can communicate each other. The policy is made to meet the most efficient requirements. When the final destination of the user is in Region I, as per the policy and efficient requirement, the global operating system should communicate with the regional operating system in Region I. However, if the reality says that the regional operating system in Region I is not available, should we wait for its availability or we should use other regional operating system in Region II to make the transmission even more efficient? Logical Control of PCN will provide us the best solution.

As aspect of reactive vs preventive control, the network of PCN will be able to make decision logically when to control reactively, and when to control preventively without question. For example, when the fixed routing is determined, the network of PCN preventively and logically controls to ensure the transmission will be carried out without error. When the accident happens, the reactively logical control will make the decision to ensure the transmission will be either dropped up, or transfer the data to the final destination.

Universal Platform

Besides the fixed routing, Universal Platform is another feature that the network of PCN has. The network of PCN can provide a universal platform for all kinds of applications developed with different operating system, such as Windows, MAC, UNIX and so on.

Universal platform provided to each application logically connected to the network of PCN contains an exchanging system to convert the application from the specific operating system with which the application is developed into the universal platform which allows the application work in the platform of PCN (shown as FIG. 12).

Email Servers in the Network of PCN

Email service in the network of PCN can be considered as public application, as same as the post mail service provided by United States Post Office today. It is provided with Email Server.

Email Server is developed with two major procedures: one is to computerize the functions, and the other is to networkize the functions.

Computerized functions include: creating the email, editing the email, wrapping the message with the envelop, while the networkized functions include: using Email Transmission Protocols (EMTP) in the layers of TCP; determining fixed routing to deliver the email to the receipts(s)' interface (s) by cooperating and collaborating with Email Servers in other operating systems in the fixed routing with TCP Availability Server.

The interface of user's small network will have software, same as POP3 used for the internet today to store and deliver the message to the user's computer.

Email Server in the network of PCN can provide the functions and features which the internet can't do well today. For example, Email Server in PCN and provide the computer users with multiple inboxes to separate business email and private email, important emails and junk emails.

Inner Connections

Inner Connections is defined by two different elements in same location, or two same elements in different locations with same identification numbers. It results from the definition of the identification numbers of the elements, and the location of the element defined by the country code and area code, and it will increase the efficiency of PCN.

As mentioned, the address of element in PCN is defined: country code+area code+identification number.

Inner Connections are defined based on the architecture of the network of PCN, which logically controls the performance of the network. It also results from the fact that we can use multiple ports for the servers in the network of PCN in order to make the transmission in the network more efficient. For instance, when two computer users in same operating systems communicate each other with emails, the sender's Email Transmission Protocol (EMTP) can go to receiver's EMTP directly; when the sender has different country code and area code from the receiver and they communicate with emails, the protocol of EMTP only needs to change the destination's country code and area code and transfer the data to the destination efficiently.

Email Service in PCN can be retrieved by using a special type of service since Email Server's function is developed with the computerization of creating, editing, storing and wrapping the message and networkization of the network of PCN.

File System

File System in the network of PCN can be designed more comprehensively and functionally for both computer users and mobile users. File system in the network of PCN is not only for storing and transferring the files, but also for unifying the mobile users and computer users.

File System in the network of PCN can function with the protocol of FTP and MFTP (Mobile FTP). File System can be used by the mobile users to store the files and retrieve the files from their accounts at anytime and from anywhere. File System can also be accessed by the computer users to store their files and retrieve their files after unifying the mobile system with the network of PCN.

1. The purposes of the network of PCN are to provide a closed network with centralized services, functions and features. More importantly, it enables us to solve the problems existing in the internet network today, comprising:

2. The system of claim 1: The network of PCN is a closed network to centralize all the services, functions and features inside the network, and all the users are the service receivers.

3. The system of claim 1: The network of PCN can networkize the services like “Home Security System” after the services are developed by the computerization in order to provide the services of applications in high security.

4. The system of claim 1: The network of PCN can solve the problems that we have with internet today. For example, it can sort out all the applications in the network by the content so that the users can choose to subscribe to keep the children from the improper applications.

5. The system of claim 1: The network can accomplish semi-procedures of the applications and use the network of PCN to improve the services of the applications for the application providers.

6. The Architecture of the network of PCN which logically connects the computer users, provides a closed network with centralized services, functions and features to all the users over the world, comprising:

7. The system of claim 6: The architecture of the network of PCN consists of Small Network of computer users, interface, routers, Local Operating System, Regional Operating System, Global Operating System and transmission system.

8. The system of claim 6: Local Operating System, Regional Operating System, Global Operating System are developed in the central buildings and distributed over the world.

9. The system of claim 6: Local Operating System, Regional Operating System, Global Operating System, as well as Small Network at home are identified by the country codes, area codes and their own identification numbers.

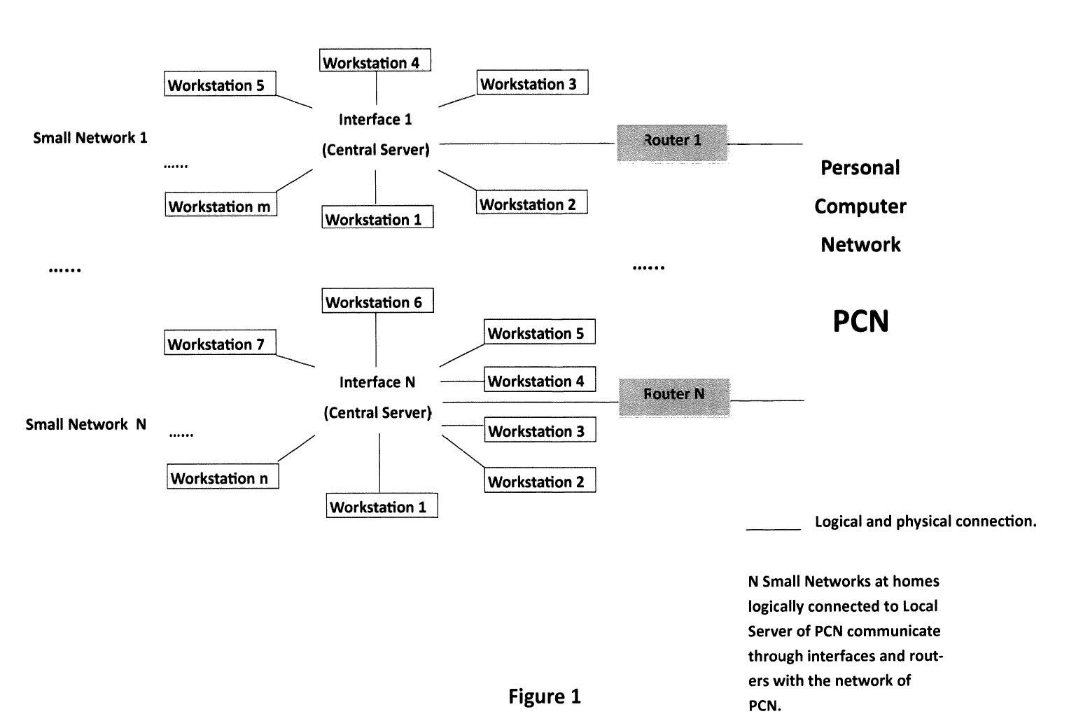

10. The system of claim 6: The workstations of Small Network at home are connected to the interface (central server) to establish a Home Network, and communicate with the network of PCN through the interface and router (Shown as FIG. 1). The workstations have open configuring systems so that the network of PCN can update all the services, functions and feature inside the network. The open configuring systems of users' computers at least need to meet the demand of expanding and extending of the network, for the purpose to communicate with the service providers and updated by the network.

11. The system of claim 6: The router used by Home Network connects the interface to the network of PCN. It can route the user to the most favorable local server in the network, modulating, multiplexing and centralizing the data and connecting the computer user logically to the network of PCN.

12. The system of claim 6: The computer users are divided into the groups in order to be logically connected to the local server of the network of PCN (shown as FIG. 3).

13. The system of claim 6: The data structure from the interface to Local Server contains the indications of the beginning of the data, direction of the data, type of the service, type of searching, user's address, network address, workstation Ds and applications' IDs, locations, data, serial number and error checking (Shown as FIG. 8).

14. The system of claim 6: The layer of interface uses separated ports for the outgoing data and incoming data with one or multiple protocols' control (Shown as FIG. 8).

15. The system of claim 6: The layer of interface has separated ports as well for different type of services or important services, such as Email, HTTP and Customized Applications.

16. The system of claim 6: The layer of network uses two sets of protocols to communicate with the interface and the functional servers inside the network. One set is for the incoming/outgoing data from/to the interfaces, and the other set is for the outgoing/incoming data to/from the servers inside the network.

17. The system of claim 6: Local Operating System, Regional Operating System and Global Operating System are module designed for the purpose to expand and extend the capabilities of the services, functions and features.

18. The system of claim 6: All the applications in the network will be developed in the Application Servers to make local searching and global searching more efficiently with defining the address: country code+area code and identification number. The identification number defines the application's catalogue, and it can make searching more efficient.

19. The system of claim 6: All the applications in the network will be defined as Public Applications, Private Applications including Customized Applications and Secret Applications for the purposes of sufficiency, security and efficiency.

20. The system of claim 6: One of the major features of the network of PCN is having Fixed Routing with the information of TCP Availability Server and Time/Routing Table, which provide the information of availabilities of all the protocols in the country and the time to transfer the data from one place to another.

21. The system of claim 6: Inner Connections, which are the connections between two same elements in different locations or two different elements in the same location, can be defined in the network of PCN after the addressing system is established for the performance of the network in high secure and efficient environment.

22. The system of claim 6: The universal platform is a unique feature of the network of PCN to provide all the applications connected to the network and developed with different operating system to work in the same network environment.

23. The system of claim 6: The sorting function can be defined in the network of PCN to sort all the applications connected to the network of PCN by the content for the users to subscribe (shown as FIG. 4).

24. The system of claim 6: The recording function can be defined in the network of PCN to record all the performance of the users and applications connected to the network for the purpose of management, maintenance and investigation when needed (shown as FIG. 4).

25. The system of claim 6: Each server has its own processing control unit with the control and management servers, including Network Servers, Application Control Server, Mobile Network Server, and Mobile Computing Server and so on, and cooperates and collaborates each other in the network to perform the functions, features and services to the users (shown as FIG. 4).

26. The system of claim 6: Some servers, specially control and management servers, will have more than one processing control units, and these processing control units cooperate and collaborate each other, as well as other servers to perform the functions and features.

27. The system of claim 6: The seven layers of TCP are defined for the network of PCN in order to reduce the complexity and increase the security in the end-to-end communication, including: Interface Layer, Data Link Layer, Transmission Layer, Network Layer, Transport Layer, Application Layer and, Control and Management Layer.

28. The system of claim 6: The layer of network in PCN need be in large capability and good processing ability. More protocol ports need be applied for the layer of network for the efficiency, so that the incoming data and outgoing data from/to the interface can be separated, as well as the incoming data and outgoing data from/to the functional servers inside the network can be separated too.

29. The system of claim 6: The transmissions in the network of PCN are controlled logically to transfer the data with fixed routing.

30. The system of claim 6: The TCP layers have multiple ports for incoming data and outgoing data for the communication, as well as multiple ports for the different services.

31. The system of claim 6: The layer of Network also has functions to logically connect the users to the network, authenticate the local users, remote users and mobile users, unify the computer users and mobile users, separate the data from/to the interfaces, and sort them into the packets of unitary application by the type of service, and sort them by the location before sending them to the destinations.

32. The system of claim 6: The layer of Network also has separated ports for different type of services controlled by the protocol(s).

33. The system of claim 6: The layer of Network cooperates and collaborates with Mobile Network Server, Mobile Computing Server and File Server to unify the mobile users with their Home Network.

34. The system of claim 6: The data traffic and congestion in the network of PCN can be well controlled logically at the level of protocol.

35. The system of claim 6: The level of controlling the traffic and congestion can be performed at the level of protocols and between the nodes in the end-to-end communication in the network of PCN logically.

36. The system of claim 6: The logical control of traffic and congestion in the network of PCN can be considered in the manners of reality vs policy control and reactive vs preventive control.

37. The system of claim 6: There are two major types of data structures in the network of PCN. One is between the interface and network (shown as FIG. 8), and the other is for the data flowing inside the network (shown as FIG. 9).

38. The system of claim 6: The data structure for the layer of interface contains all the indications of IDs of the computers at home, as well as their data. It also contains the version containing the indications of type of service, the direction of data, the type of searching and the beginning of the data for the purpose of synchronous transmission.

39. The system of claim 6: The data structure for the data flowing inside the network contain all the addresses in the fixed routing, as well as the version containing the indications of type of services, the direction of the data, the type of searching and the beginning of the data.

40. The system of claim 6: The fixed assignment scheme, centralized assignment scheme and distribute assignment scheme are applied to fully function for the global network for the fixed routing, logically networking users to the network, transfer the data, and other functions and features in the network of PCN.

41. The module-designed servers in the network, including Networking Server, Application Control Server, Customized Application Server, Mobile Network Server, Mobile Computing Server, Application Server, Initial Server, File Server, Recording Server and so on, will cooperate and collaborate each other to perform the services, functions and features centrally, comprising:

42. The system of claim 41: The module-designed Network server has functions of logical connection with Home Network, authentication of the local users, remote users and mobile users, unification of mobile users with their Home Network. Network Server can also process the data from/to the user's interface, as well as communicate with the functional servers inside the network.

43. The system of claim 41: The functions of module-designed Application Control Server include, but not exclude, sorting the data packets by the country code, area code into the unitary applications, control and process the applications connected to the network, and cooperate and collaborate with other functional servers (shown as FIG. 4).

44. The system of claim 41: The functions of module-designed TCP Availability Server include, but not exclude, logically connecting the protocols of the servers, updating and providing the information of the status of all the protocols to the sending server to determine the fixed routing, and updating the information of the status of all the protocols in the country.

45. The system of claim 41: The module-designed Application Servers in the network of PCN contain the applications in the server for the searching locally and globally.

46. The system of claim 41: The module-designed Application Servers can be connected each other except some application servers which contain the secret applications, or they are not associated with any other application servers.

47. The system of claim 41: The module-designed Application Servers have their own Application Name Servers and Browsers for the searching, and the applications in the application servers can be developed with HTML language and linked each other.

48. The architecture of the network of PCN defines the connections and performance locally, regionally and globally. It makes them function well to use interface control, data link control, path control, transmission control and network processing control, comprising:

49. The system of claim 48: The interface control includes data controlling and processing for the workstations in Home Network, and communicating with the local operating system of the network.

50. The system of claim 48: The data control includes encapsulating data packets for the communication with the local server of the network.

51. The system of claim 48: The path control includes determining the most favorable local operating system and providing logical control to connect the computer users to the network.

52. The system of claim 48: The transmission control includes the logical control for the layer of transmission to the higher performance at the layer of network.

53. They system of claim 48: The network processing control includes controlling the servers inside the network to perform the services, functions and features for both computer users and mobile users.

54. Seven Layers of TCP are defined for the network of PCN. They are: Interface Layer, Data Link Layer, Transmission Layer, Network Layer, Transport Layer, Application Layer and, Control and Management Layer, comprising:

55. The system of claim 54: With the architecture of the network, the TCP protocol doesn't need to be a suite with neither User Protocol (UP) nor Network Protocol (NP), to increases the efficiency of the network greatly.

56. The system of claim 54: Each server, including the interfaces, use separated ports of protocol to control the incoming and outgoing data in the network of PCN.

57. The system of claim 54: We use multiple ports for multiple types of services, like Email, HTTP, Customized Applications and so on.

58. The system of claim 54: For the layer of Interface, its functions include controlling and processing the data, communicating with the network.

59. The system of claim 54: The layer of interface will be configured logically by the network of PCN and configuring the workstations logically and physically in order to operate and collaborate with the network of PCN.

60. The system of claim 54: For the layer of Data Link, it encapsulates the data into the packets which are structured for indications of the beginning of the data, direction of the data, searching type and service type, User Address, Network Address, Workstation Identifications, Application Identifications, their Data, Serial Number and Error Checking.

61. The system of claim 54: For the layer of Transmission, it transfers the data between the interface of Home Network and the network of PCN with logical control.

62. The system of claim 54: For the layer of Network, it authenticates the local and remote users connected to the network, as well as mobile users.

63. The system of claim 54: The network of PCN will have separated ports for the incoming data and outgoing data communicating with the interfaces and have separating ports of the incoming data and outgoing data communicating with the functional servers in the operating system.

64. The system of claim 54: For the incoming data, the network layer will separate the incoming data into the single application packets and sort them by the data from other locations before sending them out to the applications in the destination.

65. The system of claim 54: The layer of network cooperates and collaborates with mobile network server and computing server in the network to unify the mobile users to their Home Networks.

66. The system of claim 54: The layer of transport is to transfer data from one host to another inside the network.

67. The system of claim 54: The layer of application refers to the both functional applications and service applications inside the network.

68. The system of claim 54: The layer of Control and Management is to control and manage the performance of the network of PCN to make all the servers cooperate and collaborate each other.

69. With the architecture of the network of PCN, the searching system of the network can be defined for Local Searching and Global Searching to make the searching system of the network of PCN more efficient, sufficient, flexible and convenient, comprising:

70. The system of claim 69: The searching system of the network of PCN starts at the interface of Home Network, in which Network Directory contains the classifications and locations of all the applications in the network, and the users can define the local searching by defining the both classification and location of the application, and define the global searching by defining the classification only or location only of the application.

71. The system of claim 69: The local searching and global searching can be switched with the configuration of manuals of standard display page.

72. The system of claim 69: The address of application connected to the network is determined with the addressing system in the network of PCN, which is country code+area code+identification number. The country code and area code define the application's location, while the identification number of the application defines its classification and the levels of the classification inclusively, which the searching can rely on. The definition of addressing provides searching systems of the network of PCN with more efficiency by searching partially or completely of the addresses.

73. The system of claim 69: The searching in the network of PCN is using the method of intersection searching, which means that definitions of classification or location can be crossing each other during the searching (shown as FIG. 5).

74. The system of claim 69: With the architecture of the network of PCN, the scale of the searching can be defined in the detailed locations for the searching. For example, the searching can be defined in the multiple locals, multiple regions or multiple countries for the global searching.

75. The system of claim 69: The searching systems in the network of PCN with multiple Application Name Servers and Browsers are established and each Application Server has its own Application Name Server and Browser for the searching.

76. The system of claim 69: The global searching in the network of PCN after the user defines the classification only or location only will be performed by Initial Server with its own global Application Name Server and Browser, which is functioning with the cooperative and collaborative functions of Network Server, Application Control Server and other functional and informational servers.

77. With the architecture of the network of PCN, the fixed routing can be defined with the information from TCP Availability Server and Time/Routing Table in logical control, comprising:

78. The system of claim 77: The fixed routing is a major feature of the network of PCN determined by the sending application and controlled logically with the information from TCP Availability Server and Time/Routing Table dynamically.

79. The system of claim 77: Each country in the network of PCN has its own TCP Availability Server and TCP Availability Server contains the dynamic status of all the TCP protocols in the country, so when the data arrives in the foreign country and the foreign country will be able to determine the fixed routing in its own country.

80. The system of claim 77: There are three functions of TCP Availability Server: One is to dynamically record the status of the protocols in the network of PCN; two is to provide the application server with the information of TCP protocols' status to determine the fixed routing in the country; and three is to manage and organize the status of TCP protocols physically and logically in order to enable application server to retrieve the information easily.

81. The system of claim 77: The Time/Routing Table is established after the sending server determined the fixed routing to transfer the data with the information of each node or protocol in the route and the time needed to transfer the data from one node to another.

82. The system of claim 77: The time to transfer the data from one node to another is dynamically updated in the Time/Routing Table with TCP Availability Server and logic control.

83. The system of claim 77: The rules of fixed routing say that: the user communicates with the local operating system; two local users connected to the same Local Operating System can communicate directly through Local Operating System; two local operating systems in the region can communicate each other; regional operating system can communicate with any local operating system in the region; two regional operating systems in the country can communicate each other; global operating system can communicate with any regional operating system in the country; and two global operating systems in the world can communicate each other.

84. They system of claim 77: The fixed routing, TCP Availability Server and Time/Routing Table are defined for the data transfer in the country, and the foreign country will define the fixed routing, TCP Availability Server and T/R Table in its own country for the higher efficiency.

85. In the network of PCN, Transmission Control Protocol (TCP) doesn't need to suite with User Protocol (UP) and Network Protocol (NP) to transfer the data. At mean time, the architecture of the network of PCN defines the data structure of the network of PCN different from the data structure of internet network below inclusively, comprising:

86. The system of claim 85: In the network of PCN, the data structure between the layer of interface and the layer of network is different from the data structure flowing inside the network of PCN, which results from the architecture of the network of PCN and the purpose of transmission.

87. The system of claim 85: The data structure between the layer of interface and the layer of network contains the indications of the beginning of the data, the directions of data, searching type and service type, as well as user address, network address, workstation identification numbers, application identification numbers, locations, data, serial number and error checking (Shown as FIG. 8).

88. The system of claim 85: After the network separates the data from the users, the network will integrate them into the unitary application the type of service, and then sort them out by the country codes and area codes before sending them to their destination with fixed routing.

89. The system of claim 85: The data structure flowing inside the network contains the data structure between the layer of interface and network and all the addresses in the fixed routing (Shown as FIG. 9).
